(19) United States
(12) Patent Application Publication
(10) Pub. No.: US 2007/0021960 A1
(43) Pub. Date: Jan. 25, 2007

(54) System and method for communicating with a network

(76) Inventor: Marc McLean, Mentor, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/185,120

(22) Filed: Jul. 20, 2005

(51) Int. Cl. G10L 15/04

(52) U.S. Cl. 704/251

(57) ABSTRACT

Systems and methods of performing searches on a network or computer are provided. The method includes, for example, reading an audio input that comprises speech and converting the speech to at least one text string. The method may also include identifying at least one word associated with initiating a search on the network or computer in the text string and identifying one or more words following the at least one word associated with initiating a search. The method also forms a search engine URL or address that includes the identified one or more words following the at least one word associated with initiating the search.

### BACKGROUND

Computer users typically interface with the World Wide Web (WWW) or the Internet through computer systems running a browser application such as, for example, Internet Explorer by Microsoft Corporation of Redmond, Wash., or Netscape Navigator by Netscape Communications Corp. of Mountain View, Calif. While these browser applications provide useful ways of communicating with the Internet, it is desirable to further expand users' abilities to communication with the Internet and other networks.

### SUMMARY

Systems and methods for performing searches on a network or computer are provided. The method includes, for example, reading an audio input that comprises speech and converting the speech to at least one text string. The method may also include identifying at least one word associated with initiating a search on the network or computer in the text string and identifying one or more words following the at least one word associated with initiating a search. The method also forms a search engine URL or address that includes the identified one or more words following the at least one word associated with initiating the search.

### BRIEF DESCRIPTION OF THE DRAWINGS

FIG. 1 is an exemplary system diagram in accordance with one embodiment;

FIG. 2 is an exemplary system diagram in accordance with a second embodiment;

FIG. 3 is one embodiment of a network communication flow diagram; and

FIG. 4 is another embodiment of a network communication flow diagram.

FIG. 5 is a flow diagram of one embodiment of a text-to-speech engine.

### DETAILED DESCRIPTION OF ILLUSTRATED EMBODIMENTS

The following includes definitions of exemplary terms used throughout the disclosure. Both singular and plural forms of all terms fall within each meaning:

“Signal”, as used herein includes, but is not limited to, one or more electrical signals, analog or digital signals, optical or light (electro-magnetic) signals, one or more computer instructions, a bit or bit stream, or the like.

“Computer system” or “computer” as used herein includes, but is not limited to, any programmed or programmable electronic device that can store, retrieve, and process data.

“Software”, as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Logic”, synonymous with “circuit” as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software.

“Browser” as used herein includes, but is not limited to, any computer program used for accessing sites or information on a network (as the World Wide Web) including, for example, toolbars and application programs.

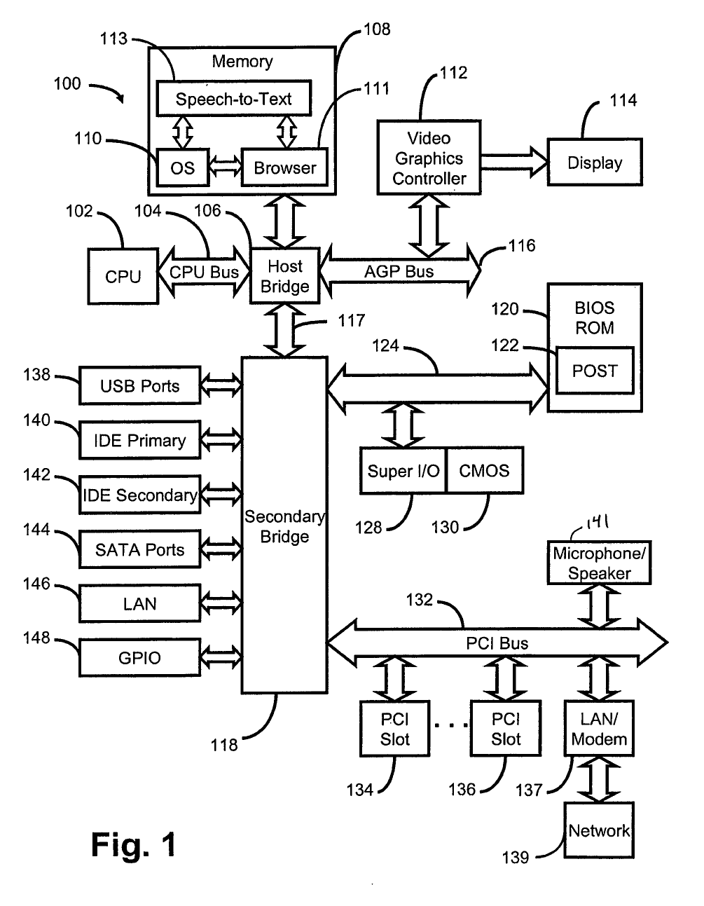

Referring now to FIG. 1, a computer system 100 constructed in accordance with one embodiment generally includes a central processing unit (“CPU”) 102 coupled to a host bridge logic device 106 over a CPU bus 104. CPU 102 may include any processor suitable for a computer such as, for example, a Pentium class processor provided by Intel. A system memory 108, which preferably is one or more synchronous dynamic random access memory (“SDRAM”) devices (or other suitable type of memory device), couples to host bridge 106 via a memory bus. Further, a graphics controller 112, which provides video and graphics signals to a display 114, couples to host bridge 106 by way of a suitable graphics bus, such as the Advanced Graphics Port (“AGP”) bus 116. A display 114 may be a Cathode Ray Tube, liquid crystal display or any other similar visual output device. Host bridge 106 also couples to a secondary bridge 118 via bus 117.

Secondary Bridge 118 is an I/O controller chipset. The secondary bridge 118 interfaces a variety of I/O or peripheral devices to CPU 102 and memory 108 via the host bridge 106. The host bridge 106 permits the CPU 102 to read data from or write data to system memory 108. Further, through host bridge 106, the CPU 102 can communicate with I/O devices connected to the secondary bridge 118 and, and similarly, I/O devices can read data from and write data to system memory 108 via the secondary bridge 118 and host bridge 106. The host bridge 106 preferably has memory controller and arbiter logic (not specifically shown) to provide controlled and efficient access to system memory 108 by the various devices in computer system 100 such as CPU 102 and the various I/O devices. A suitable host bridge is, for example, a Memory Controller Hub such as the Intel® 875P Chipset described in the Intel® 83875P (MCH) Datasheet, which is hereby fully incorporated by reference.

Referring still to FIG. 1, secondary bridge logic device 118 may be an Intel® 83801EB I/O Controller Hub 5 (ICH5)/Intel® 83801ER I/O Controller Hub 5 R (ICH5R) device provided by Intel and described in the Intel® 83801EB ICH5/83801ER ICH5R Datasheet, which is incorporated herein by reference in its entirety. The secondary bridge includes various controller logic for interfacing devices connected to Universal Serial Bus (USB) ports 138, Integrated Drive Electronics (IDE) primary and secondary channels (also known as parallel ATA channels or sub-system) 140 and 142, Serial ATA ports or sub-systems 144, Local Area Network (LAN) connections 146, and general purpose I/O (GPIO) ports 148. Secondary bridge 118 also includes a bus 124 for interfacing with BIOS ROM 120, super I/O 128, and CMOS non-volatile memory 130. Secondary bridge 118 further has a Peripheral Component Interconnect (PCI) bus 132 for interfacing with various devices connected to PCI slots or ports 134-136. The primary IDE channel 140 can be used, for example, to couple a master hard drive device and a slave CD-ROM device (e.g., mass storage devices) to the computer system 100. Alternatively or in combination, SATA ports 144 can be used to couple such mass storage devices or additional mass storage devices to the computer system 100.

The BIOS ROM 120 includes firmware that is executed by the CPU 102 and which provides low level functions, such as access to the mass storage devices connected to secondary bridge 118. The BIOS firmware also contains the instructions executed by CPU 102 to conduct System Management Interrupt (SMI) handling and Power-On-Self-Test (“POST”) 122. POST 122 is a subset of instructions contained with the BIOS ROM 120. During the boot up process, CPU 102 copies the BIOS to system memory 108 to permit faster access.

The super I/O device 128 provides various inputs and output functions. For example, the super I/O device 128 may include a serial port and a parallel port (both not shown) for connecting peripheral devices that communicate over a serial line or a parallel pathway. Super I/O device 128 preferably also includes a non-volatile memory portion 130 in which various parameters can be stored and retrieved. These parameters may be system and user specified configuration information for the computer system such as, for example, user selections from computer set-up or system configuration information. The memory portion 130 in National Semiconductor's 97448VJG is a complementary metal oxide semiconductor (“CMOS”) memory portion. Memory portion 130, however, can be located elsewhere in the system.

The operation of various components in the computer system shown in FIG. 1 will now be briefly described. The CPU 102 executes user application software and system firmware and software such as the operating system (OS) 110, device drivers and BIOS firmware, which may reside or be loaded into memory 108. The System BIOS firmware 120 contains routines that permit direct interface with hardware (e.g., mass storage devices) connected to the computer system 100. Generally, an application program under control of the operating system makes a request for a resource. The operating system may send the request to the file system or initiate a call to the appropriate device driver corresponding to the bridge that can service the request. Memory 108 may include one or more browser applications 111 and one or more speech-to-text engines 113, text filtering modules, and/or browser control modules. The browser applications 111 can include Microsoft Internet Explorer or Netscape Navigator, a toolbar such as the Google Toolbar or Deskbar, or custom-designed toolbars, deskbars, or applications.

Browser applications 111 access the LAN/Modem 137 through OS 110 to communicate to Network 139. Network 139 can be a local area network, the Internet or other network. Information and data is sent back and forth between the browser applications 111 and the Network 139. Users interact with the browser applications 111 via keyboards, microphones and other input devices connected to USB Ports 138 or other ports. Computer system 100 also includes the capability to generate audio and record or sample audio with microphone/speaker components 141.

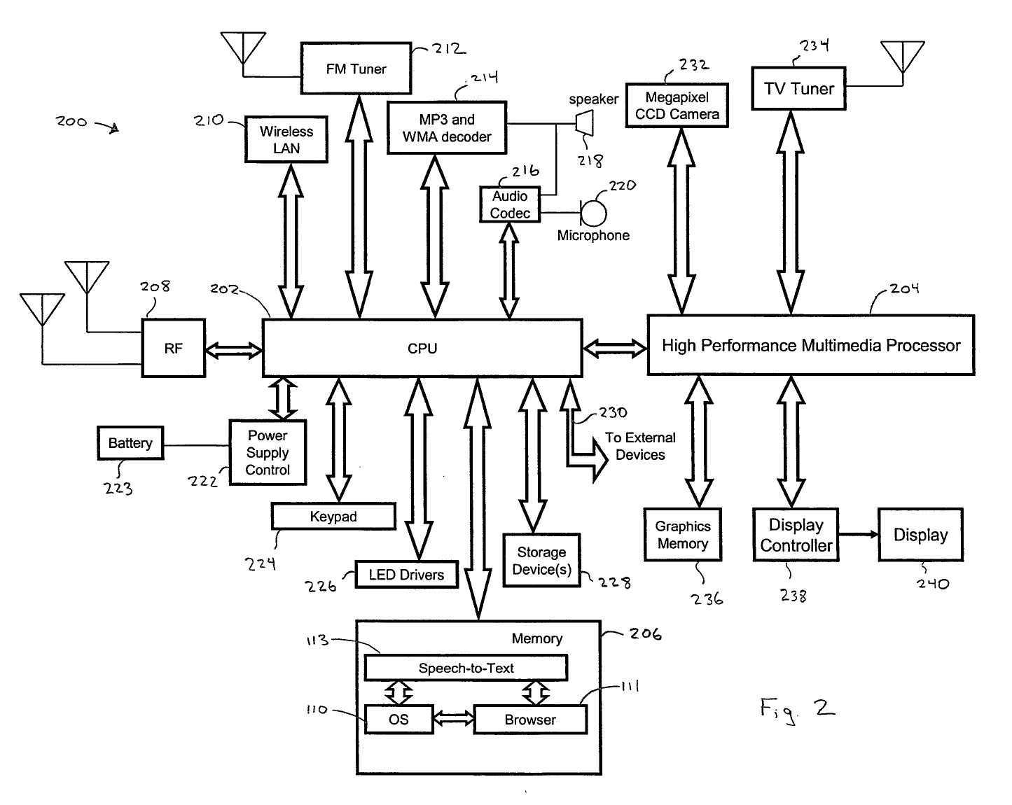

FIG. 2 illustrates another embodiment of a computer system 200. System 200 can be in the form of, for example, a mobile smart phone, mobile PC, pocket PC, Personal Digital Assistant, or the like. System 200 includes a processor (CPU) 202 and a high-performance multimedia processor 204, which communicates with CPU 202. CPU 202 is in communication with several components including, for example, memory 206, RF transceiver/modem 208, wireless Local Area Network (LAN) modem 210, Frequency Modulation (FM) tuner 212, MP3 and WMA decoders 214, and audio coders and decoders (codec) 216. MP3 and WMA decoders 214 and audio codec 216 communicates with one or more speakers 218 to provide audio output. Audio codec 216 also communicates with one or more microphones 220 for the input of audio. The audio can be coded into digital signals by audio codec 216 for processing by CPU 202 and application programs.

CPU 202 also communicates with one or more keypads 224, Light Emitting Devices (LED) drivers 226, and one or more storage devices 228, which can be any variety of Read Only Memories (ROM), Random Access Memories (RAM), or disk drives. Other memories may also be used. CPU 202 further communicates with one or more bus interfaces 230 that allow connection with external devices. One example of a bus interface is the Universal Serial Bus (USB). Other buses may also be used. A power supply control 222 and battery 223 provide power to CPU 202 and all other components requiring electrical energy.

High-performance multimedia processor 204 communicates with several components such as, for example, mega-pixel cameral 232, Television (TV) tuner 234, graphics memory 236, and display controller 238. Display controller 238 communicates with display 240 to provide graphical and visual information to users.

Memory 206 may include one or more browser applications 111 and one or more speech-to-text engines 113, text filtering modules, and/or browser control modules. The browser applications 111 can include one or more browsers by Microsoft Corporation or Netscape Communication Corporation, toolbars, deskbars, or applications. OS 110 can further include the Windows CE operating system or Windows Mobile operating system by Microsoft Corporation or other operating systems.

The operation of system 200 of FIG. 2 is similar to system 100 of FIG. 1. For example, CPU 202 executes application software and system firmware and software such as the operating system (OS) 110, device drivers and BIOS firmware, which may reside or be loaded into memory 206. Browser applications 111 access the LAN/Modem 210 or RF transceiver modem 208 through OS 110 to communicate to networks that may be wireless. Information and data is sent back and forth between the browser applications 111 and the network. Users interact with the browser applications 111 via keyboards/pads, microphones and other input devices. Computer system 200 also includes the capability to generate audio and record or sample audio with microphone/speaker components 220 and 218.

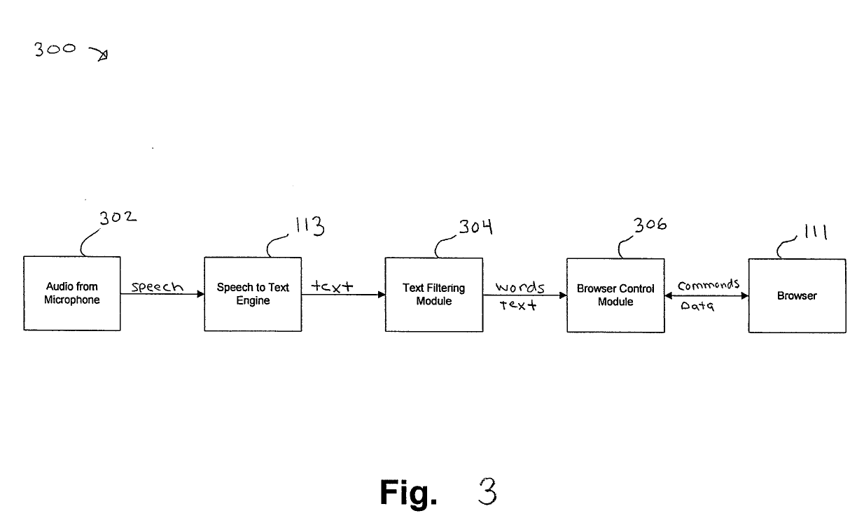

FIG. 3 is one embodiment of a network communication flow diagram 300. The rectangular elements denote “processing blocks” and represent computer software instructions or groups of instructions. The diamond shaped elements denote “decision blocks” and represent computer software instructions or groups of instructions which affect the execution of the computer software instructions represented by the processing blocks. Alternatively, the processing and decision blocks represent steps performed by functionally equivalent circuits such as a digital signal processor circuit or an application-specific integrated circuit (ASIC). The flow diagram does not depict syntax of any particular programming language. Rather, the flow diagram illustrates the functional information one skilled in the art may use to fabricate circuits or to generate computer software to perform the processing of the system. It should be noted that many routine program elements, such as initialization of loops and variables and the use of temporary variables are not shown.

The flow diagram 300 starts in block 302 where an audio input from microphone 141/220 is read. The input is analyzed by speech-to-text engine 113. Speech-to-text engine 113 is an application or program that converts audio sounds (e.g., speech) to text or words. One example of a speech-to-text engine is SR Engine by Microsoft Corporation of Redmond, Wash., provided as a redistributable library of software files or included in the Speech Application Programming Interface (SAPI) software development kit (SDK). The words or text are input to a text filtering module 304 that identifies one or more key words from the plurality of text or words output by the speech-to-text engine. Filter 304 can have a plurality of settings ranging from off, where no text or words are filtered, to a target setting where only targeted or key text or words are allowed to pass through the filter. One example of a target setting is provided by comparing the text or words to one or more key text or words in a library of key text or words. The text or words that match the key text or words would by output by the filter to browser control module 306.

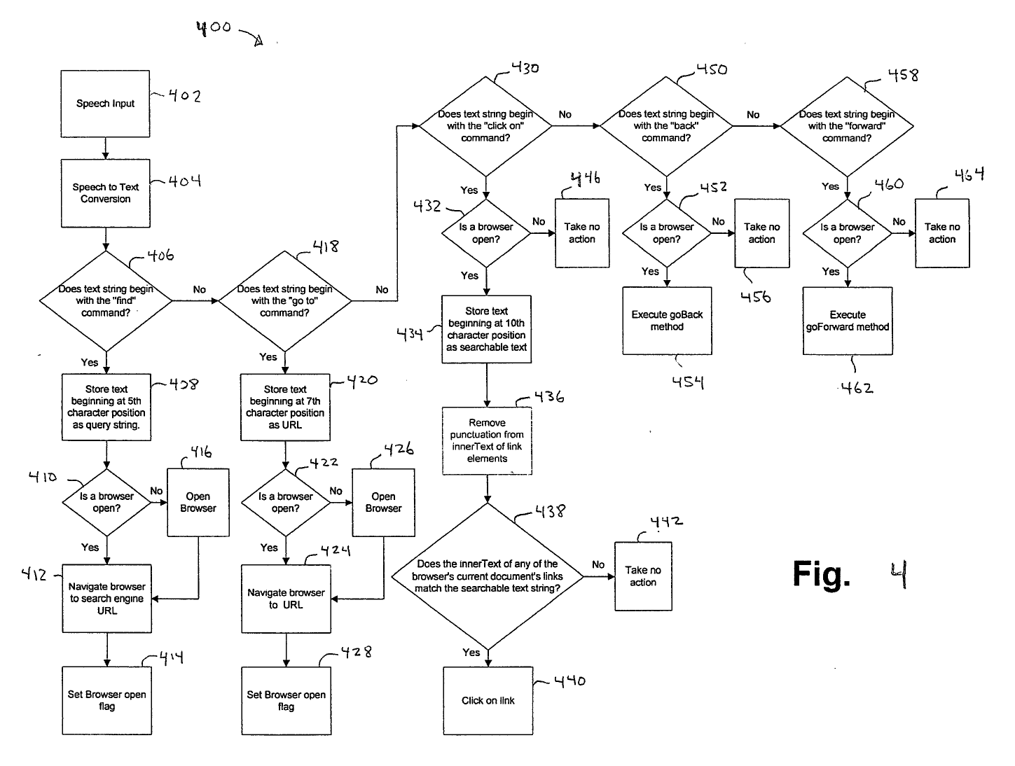

Browser control module 306 reads the output of filter 304 and places the text or words coming from filter 306 into one or more browser control instructions, which will be described in more detail in connection with FIG. 4. Browser control module 306 outputs the control instructions to browser application 111 for execution. Additional data between browser control module 306 and browser 111 can also be transferred such as, for example, error instructions or other feedback including data and instructions associated with a browser event, e.g., selected text after a user right-clicks in a browser's document. In one embodiment, the browser control instructions cause browser 111 to navigate to one or more websites, select or “click” on text appearing in a browser window, and/or to navigate one or more links appearing on a website.

Referring now to FIG. 4, a flow diagram 400 of another embodiment of the invention is shown. The flow starts in block 402 where audio or speech is input and read. As described above, this takes audio from a microphone and converts it to a digital signal that can be analyzed by the computer system. The digital audio signal is converted by the speech-to-text engine 113 to text in block 404. One suitable conversion includes converting the digital audio signal to a text string that is stored in memory.

Block 406 determines if the text string starts with the word “find” and associated the word find with a “find” command. If the text string begins with the word “find,” then block 408 stores the text beginning at the 5th character position as a query string. The fifth character position is the position after the characters that make up the word “find” in the text string plus an additional character space in the text string.

Block 410 determines if a browser application is already open in the operating system. If not, a browser application is opened in block 416. If a browser application is already open or has been opened, block 412 sends a browser command to navigate the browser application to a search engine URL (Universal Resource Locator) address. This can be accomplished by, for example, forming a URL address of a search engine that includes the search engine's domain address plus a query string that includes the stored text string. This URL address is sent via, for example, the Navigate or Navigate2 method in Internet Explorer, to the browser application. Block 414 sets a browser open flag to indicate that the browser is open for future knowledge of the browser's status. The flow then returns to block 402 for the next cycle or speech input.

In block 406, if the text string does not being with the word “find”, block 418 determines if the text string begins with the words “go to.” If the text string begins with the words “go to,” then block 420 stores the text beginning at the 7th character position as an URL address of a website. The seventh character position is the position after the characters that make up the words “go to” plus an additional character space in the text string.

Block 422 determines if a browser application is already open in the operating system. If not, a browser application is opened in block 426. If a browser application is already open or has been opened, block 424 sends a browser command to navigate the browser application to a URL (Universal Resource Locator) address of the website. This can be accomplished by, for example, executing the Navigate or Navigate2 method of Internet Explorer. Block 428 sets a browser open flag to indicate that the browser is open. The flow returns to block 402 for the next cycle or speech input.

In block 418, if the text string does not begin with the words “go to,” block 430 determines if the text string begins with the words “click on.” If yes, block 432 determines if a browser application is open. If no browser application is open, block 446 takes no action and the flow returns to block 402 for the next cycle. If a browser application is open, block 434 stores the text beginning at the 10th character position as search text for the webpage on the open browser. The 10th character position is the position after the characters that make up the words “click on” plus an additional character space in the text string. Block 436 removes punctuation from the innerText property of link elements in an HTML document. InnerText properties of all objects are exposed through the HTML Document Object Model. InnerText properties of objects are contained with a website's source code and typically include punctuation. One example of an innerText property listing is as follows:

<P ID=oPara>This text string will change.</P>
:
<BUTTON onclick=“oPara.innerText=‘When you
clicked, it changed.’”>Change text</BUTTON>
<BUTTON onclick=“oPara.innerText=‘When you
clicked again, it changed again.’”>Reset</BUTTON>

Block 438 determines if any of the HTML document link's innerText match the search text from block 434. This can be done by comparing the search string to the innerText text strings for identical matches. Other matches can also be employed such as fuzzy matches or phonetic matches. If there is no match, block 442 takes no action and the flow loops back to block 402 for the next cycle. If there is a match, the link is clicked on in block 440.The browser application navigates to the link or website of the matching innerText text string. The flow then loops back to block 402 for the next cycle or speech input.

In block 430, if the text string does not begin with the words “click on,” block 450 determines if the text string begins with the word “back.” If yes, block 452 determines if the browser application is open. If not, block 456 ends the flow and loops back to block 402 for the next cycle or speech input. If the browser application is open in block 452, then block 454 sends a “goBack” command to the browser application for execution. This commands navigates the browser application back to its previous URL, assuming there is such a location in the navigation history of the browser application. Following block 454, the flow loops back to block 402 for the next cycle or speech input.

In block 450, if the text string does not begin with the word “back,” block 458 determines if it begins with the word “forward.” If yes, block 460 determines if the browser application is open. If not, block 464 ends the flow and loops back to block 403 for the next cycle or speech input. If the browser application is open in block 460, then block 462 sends a “goForward” command to the browser application for execution. This commands navigates the browser application forward to its previous URL, assuming there is such a location in the navigation history of the browser application. Following block 462, the flow loops back to block 402 for the next cycle or speech input. Other methods of implementing the command filtering portion of FIG. 4 can also be employed. For example, the Microsoft SR engine may be modified by adding custom user-defined commands and instructions via a look-up file. The SR engine's functionality is thus expanded and extended through reference to this file.

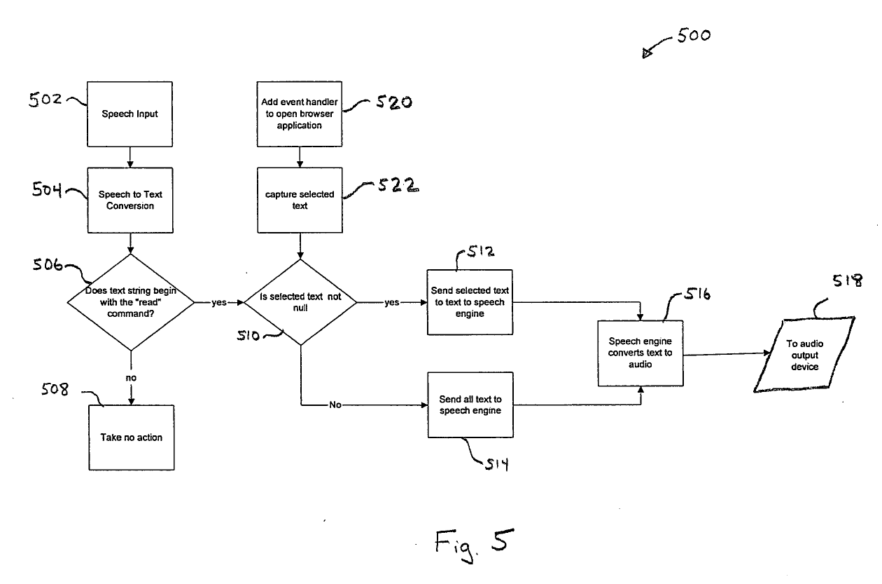

FIG. 5 illustrates one embodiment of text-to-speech engine flow diagram 500. The text-to-speech engine may form a portion speech-to-text engine 113 or may reside on its own communicating with speech-to-text engine 113, browser 111, and residing within memory 108 (FIG. 1) or memory 206 (FIG. 2). In the embodiment of FIG. 5, the flow can start in either block 502 or block 520.

In block 502, a speech input is read. Block 504 converts the speech to a text string via the speech-to-text engine 113. Block 506 tests to determine whether the text string begins with the word or command “read.” If not, block 508 takes no action and the logic loops back to steps 502 and 520. If the text string begins with “read,” the block 510 tests to determine if any text has been “selected” by the user from block 522 for reading back in the browser application. Text may be “selected” by a user in the browser by, for example, “highlighting” the desired text with a mouse controller or keyboard. Text can be “selected” by a user by opening a browser application in blocks 416 or 426 and displaying a website or page.

If no text has been “selected,” block 514 selects or sends all of the text appearing in the browser to the text-to-speech engine. If text has been “selected” in block 510, block 512 sends the selected text in the browser to the text-to-speech engine. From either block 512 or block 514, blocks 516 and 518 convert the “selected” text to speech and provide an audio output of the text to the user. One suitable text-to-speech engine includes Microsoft's text-to-speech engine, which can perform blocks 516 and 518 through OS 110.

The flow diagrams of FIGS. 4 and 5 can be combined to generate a system which accepts as inputs spoken commands from a user and which provides as outputs to the user read or spoken text. In particular, a user may provide a spoke command to the system to open a browser application and to navigate to one or more websites or pages. The user may then provide a spoken command to the system to “read” back some portion or all of the website or page through audible speech. The system will then read back to the user the selected text appearing in the browser application.

The logic flow shown and described herein may reside in or on a computer readable medium or product such as, for example, a Read-Only Memory (ROM), Random-Access Memory (RAM), programmable read-only memory (PROM), electrically programmable read-only memory (EPROM), electrically erasable programmable read-only memory (EEPROM), magnetic disk or tape, and optically readable mediums including CD-ROM and DVD-ROM. Still further, the processes and logic described herein can be merged into one large process flow or divided into many sub-process flows. The process flows described herein may be rearranged, consolidated, and/or re-organized in their implementation as warranted or desired so long as the relative order is maintained. For example, other related or unrelated process flows can be interjected between the specified process blocks without affecting the functionality or results obtained.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. For example, embodiments of the invention can be further modified to incorporate additional speech-to-text navigation including, for example, “open” and “close” commands. Therefore, the invention, in its broader aspects, is not limited to the specific details, the representative apparatus, and illustrative examples shown and described. Accordingly, departures may be made from such details without departing from the spirit or scope of the applicant's general inventive concept.

1. A method of performing searches on a computer or network comprising:
reading an audio input that comprises speech;
converting the speech to at least one text string;
identifying at least one word associated with initiating a search on the computer system in the text string;
identifying one or more words following the at least one word associated with initiating a search; and
forming a search engine URL that includes the identified one or more words following the at least one word associated with initiating a search.

2. The method of claim 1 further comprising navigating a browser application to the formed search engine location address.
